(19) United States
(12) Patent Application Publication
(10) Pub. No.: US 2016/0154902 A1
(43) Pub. Date: Jun. 2, 2016

(54) Selective Annotation Of Circuits For Efficient Formal Verification With Low Power Design Considerations

(71) Applicant: Synopsys, Inc., Mountain View, CA (US)

(72) Inventors: Vijay Anand Korthikanti, Milpitas, CA (US); Praveen Tiwari, Mountain View, CA (US)

(21) Appl. No.: 14/596,500

(22) Filed: Jan. 14, 2015

Related U.S. Application Data
(60) Provisional application No. 62/085,598, filed on Nov. 30, 2014.

(51) Int. Cl. G06F 17/50

(52) U.S. Cl. CPC G06F 17/504; G06F 17/5045

(57) ABSTRACT

Formal verification of a circuit design is performed with low power considerations. The formal verification process receives a circuit design and a low power design specification. The low power design specification identifies power domains for the circuit. The system models undefined signal reaching nodes of the circuit from components of power domains that are switched off. The system selects a subset of nodes at which undefined signal reaches, thereby excluding certain nodes from the analysis. The selection of a small subset of nodes for analyzing undefined signals increases the efficiency of the formal verification process. The system annotates the circuit design to allow undefined signals to be introduced at the selected nodes. The system performs formal verification of the annotated circuit design.

### CROSS REFERENCE TO RELATED APPLICATION

This application claims the benefit of U.S. Provisional Patent Application 62/085,598, filed on Nov. 30, 2014, which is incorporated by reference in its entirety.

### BACKGROUND

This disclosure relates generally to formal verification of circuits and more specifically to annotation of circuits with low power considerations, for effective formal verification.

Formal verification techniques verify whether the design intent of a specification for a circuit design is preserved in a particular implementation of the circuit. The design intent for a circuit design is specified using various assertions. The formal verification techniques verify whether these assertions hold true. Conventional formal verification techniques do not consider certain types of input specification, for example, low power design. Low power design may be specified using unified power format (UPF).

A low power design specification identifies power domains associated with different portions of the circuit. Certain power domains can switch off during certain modes of the circuit. For example, certain portions of a circuit are switched on during normal operations of a device but are switched off in a low power mode. If a component of a circuit is off during a mode, the output of that component carries an undefined signal. This undefined signal can reach as input to other components of the circuit, causing signals propagating through these components to become undefined.

Therefore, power on/off combinations based on various low power modes can cause formal verification results to be invalid. Conventional formal verification techniques do not take into account the low power design specification. Therefore, the results of formal verification of the circuit design may be erroneous. Furthermore, attempting to model low power design input during a formal verification process can lead to significant increase in the complexity of the formal verification process. As a result, conventional formal verification techniques used in design of circuits that include low power specification are inadequate and may not provide conclusive results due to increased complexity of verification.

### SUMMARY

The above and other issues are addressed by a computer-implemented method, computer system, and computer readable memory storing instructions for performing formal verification of circuits under low power considerations. A low power design specification identifies power domains for the circuit. A power domain may be switched off under certain conditions, thereby providing undefined signals to nodes of the circuit. An undefined signal is a signal that is unconstrained and can take any possible logical value. The formal verification process models undefined signals at nodes of the circuit. The complexity of the formal verification process increases with the number of nodes modeled with the undefined signal. Therefore, the system selects a subset of nodes at which undefined signal reaches for performing formal analysis, thereby reducing the complexity of formal verification process.

The system annotates the circuit design so as to be able to provide undefined signal at selected nodes of the circuit. The system performs formal verification of the annotated circuit. The result of formal verification of the annotated circuit provides the result of formal verification of the input circuit with low power considerations. Annotating all nodes at which undefined signal reaches results in increased complexity of the verification process. Therefore, embodiments of the invention reduce the complexity of the verification process by identifying a subset of nodes at which undefined signal reaches. The subset of nodes at which undefined signal reaches is selected such that the accuracy of the verification process is not reduced in spite of processing fewer nodes.

The system uses different criteria to select the subset of nodes at which undefined signal is injected, i.e., provided as input by annotating the circuit. In an embodiment, the system selects a node for injecting an undefined signal if the node is at a boundary of a power domain. In other words, the system selects nodes that connect components of a power domain with components of a different power domain. Accordingly, the system excludes nodes that are internal to the power domain unless the node is connected to an output of a sequential element.

In an embodiment, the system identifies nodes of the circuit that connect two combinational components, each component powered by a distinct power supply. If the system determines that the power supplies that power the two components are equivalent based on the low power design specification, the system excludes the node from the subset of nodes identified for injecting the undefined signal.

In an embodiment, the system excludes internal nodes connected to output of a sequential element if the system determines that the power control logic of the power domain resets the state of the sequential element when the power domain state changes from off to on.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is a flowchart illustrating various operations in the design and fabrication of an integrated circuit.

FIG. 2 illustrates the system architecture for formal verification of circuits with low power design considerations, according to an embodiment.

FIG. 3 shows an example circuit for use as input for formal verification, according to an embodiment.

FIG. 4 shows an example of circuit illustrating annotations of the circuit based on low power specification, according to an embodiment.

FIG. 5 shows various nodes of a block of circuit that need to be modeled with undefined signals as input as a result of the power domain of the circuit block turning off, according to an embodiment.

FIG. 6 is a flowchart illustrating the process for performing formal verification of a circuit with low power design considerations, according to an embodiment.

FIG. 7 is a flowchart illustrating the process for selecting nodes of a circuit for injecting undefined signals based on the low power design, according to an embodiment.

FIG. 8 shows an example circuit illustrating the selection of boundary nodes and sequential elements for injecting undefined signals based on the low power design, according to an embodiment.

FIG. 9 shows an example circuit illustrating elimination of nodes at boundary of two power domains from the set of nodes selected for injecting undefined signal if the two power domains have equivalent power states, according to an embodiment.

FIG. 10 shows an example circuit illustrating annotation of a circuit for modelling power switch policy, according to an embodiment.

FIG. 11 shows an example circuit illustrating annotation of a circuit for modelling isolation policy, according to an embodiment.

FIG. 12 shows an example circuit illustrating annotation of a circuit for modelling corruption of a sequential element of a circuit, according to an embodiment.

FIG. 13 shows an example circuit illustrating annotation of a circuit for injecting undefined signal at the output of an operator, according to an embodiment.

FIG. 14 is a high-level block diagram illustrating an example of a computer for use as a system for performing formal verification with low power considerations, in accordance with an embodiment.

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. Alternative embodiments of the structures and methods illustrated herein may be employed without departing from the principles described herein.

### DETAILED DESCRIPTION

Formal verification of a circuit design in presence of low power design specification is performed by annotating the circuit design with information based on low power design specification. For example, the circuit design may be annotated to include power supplies defined in the low power design, isolation cells between power domains as specified in the low power design, signals for enabling/disabling the isolation cells and so on. The circuit is further annotated to model the state of nodes that receive undefined signal from output of components of power domains that are switched off.

In an embodiment, the system introduces an undefined signal by introducing a new variable that is unconstrained. An unconstrained variable in the formal verification process can take any logical value, for example, true or false. Modelling of undefined signals in the circuit increases the complexity of the formal verification process significantly due to introduction of large number of unconstrained variables. The complexity of formal verification process as a result of introducing N unconstrained variable increases by a factor exponential in the number of unconstrained variables introduced.

Therefore, embodiments select a subset of nodes for introducing undefined signals selectively thereby reducing the number of unconstrained variables introduced in the design. The system selects a subset of nodes such that the excluded nodes do not affect the result of the formal verification process. The reduction in the number of nodes modelled with undefined signals results in less complex circuit design as a result of annotation of the circuit based on the low power annotation. Furthermore, the reduction in the number of nodes modelled with undefined signals results in fewer unconstrained variables being introduced during the formal verification process. This results in efficient execution of the formal verification process with low power considerations.

The system uses different criteria to select the subset of nodes at which undefined signal is injected, i.e., provided as input by annotating the circuit. In an embodiment, the system selects a node for injecting an undefined signal if the node is at a boundary of a power domain. In other words, the system selects nodes that connect components of a power domain with components of a different power domain. Accordingly, the system excludes nodes that are internal to the power domain unless the node is connected to an output of a sequential element.

In an embodiment, the system identifies nodes of the circuit that connect two combinational components, each component powered by a distinct power supply. For example, a node may connect combinational component C1 with combinational component C2, wherein C1 belongs to power domain PD1 and is powered by power supply V1, whereas C2 belongs to power domain PD2 and is powered by power supply V2. If the system determines that the power supplies V1 and V2 that power the two components C1 and C2 respectively, are equivalent based on the low power design specification, the system excludes the node from the subset of nodes identified for injecting the undefined signal.

In an embodiment, the system determines whether the power control logic of the power domain resets the state of sequential elements when the power domain changes state from off to on. The system excludes internal nodes connected to output of a sequential element if the power control logic resets the state of the sequential element when the power domain state changes from off to on. In this situation, the power control logic ensures that the output states of sequential elements are not undefined after the power domain switches from off to on. Accordingly, the system determines that there is no need to inject undefined signal for these nodes.

Methods and systems for performing formal verification of circuits with low power considerations are described in U.S. patent application Ser. No. 14/542,895 filed on Nov. 17, 2014, the contents of which are incorporated herein by reference in their entirety.

### Overview of EDA Design Flow

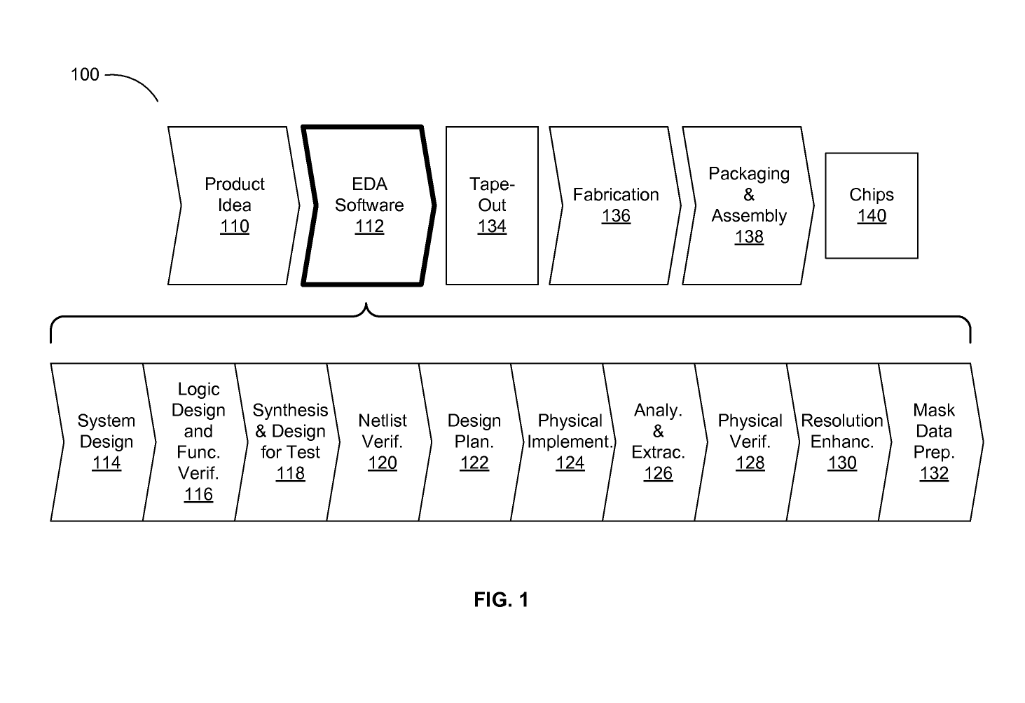

This section describes various stages in the EDA (electronic design automation) flow. FIG. 1 is a flowchart 100 illustrating the various operations in the design and fabrication of an integrated circuit. This process starts with the generation of a product idea 110, which is realized during a design process that uses electronic design automation (EDA) software 112. When the design is finalized, it can be taped-out 134. After tape-out, a semiconductor die is fabricated 136 to form the various objects (e.g., gates, metal layers, vias) in the integrated circuit design. Packaging and assembly processes 138 are performed, which result in finished chips 140.

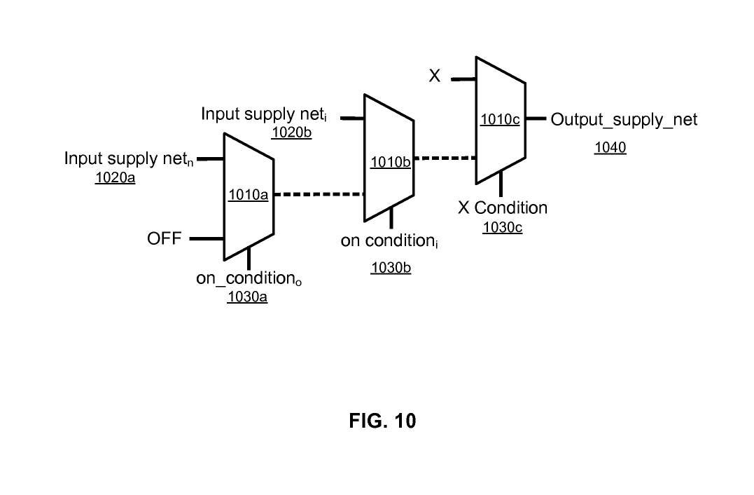

The EDA software 112 may be implemented in one or more computing devices such as the computer 1000 of FIG. 10. For example, the EDA software 112 is stored as instructions in the computer-readable medium which are executed by a processor for performing operations 114-132 of the design flow, which are described below. This design flow description is for illustration purposes. In particular, this description is not meant to limit the present disclosure. For example, an actual integrated circuit design may require a designer to perform the design operations in a difference sequence than the sequence described herein.

During system design 114, designers describe the functionality to implement. They can also perform what-if planning to refine the functionality and to check costs. Note that hardware-software architecture partitioning can occur at this stage. Example EDA software products from Synopsys, Inc. of Mountain View, Calif. that can be used at this stage include: Model Architect®, Saber®, System Studio®, and Designware® products.

During logic design and functional verification 116, VHDL or Verilog code for modules in the circuit is written and the design is checked for functional accuracy. More specifically, the design is checked to ensure that it produces the correct outputs. Example EDA software products from Synopsys, Inc. of Mountain View, Calif. that can be used at this stage include: VCS®, Vera®, 10 Designware®, Magellan®, Formality®, ESP® and Leda® products.

During synthesis and design for test 118, VHDL/Verilog is translated to a netlist. This netlist can be optimized for the target technology. Additionally, tests can be designed and implemented to check the finished chips. Example EDA software products from Synopsys, Inc. of Mountain View, Calif. that can be used at this stage include: Design Compiler®, Physical Compiler®, Test Compiler®, Power Compiler®, FPGA Compiler®, Tetramax®, and Designware® products.

During netlist verification 120, the netlist is checked for compliance with timing constraints and for correspondence with the VHDL/Verilog source code. Example EDA software products from Synopsys, Inc. of Mountain View, Calif. that can be used at this stage include: Formality®, Primetime®, and VCS® products.

During design planning 122, an overall floor plan for the chip is constructed and analyzed for timing and top-level routing. Example EDA software products from Synopsys, Inc. of Mountain View, Calif. that can be used at this stage include: Astro® and IC Compiler® products.

During physical implementation 124, the placement (positioning of circuit elements) and routing (connection of the same) occurs. Example EDA software products from Synopsys, Inc. of Mountain View, Calif. that can be used at this stage include: the Astro® and IC Compiler® products.

During analysis and extraction 126, the circuit function is verified at a transistor level, which permits refinement. Example EDA software products from Synopsys, Inc. of Mountain View, Calif. that can be used at this stage include: Astrorail®, Primerail®, Primetime®, and Star RC/XT® products.

During physical verification 128, the design is checked to ensure correctness for: manufacturing, electrical issues, lithographic issues, and circuitry. Example EDA software products from Synopsys, Inc. of Mountain View, Calif. that can be used at this stage include the Hercules® product.

During resolution enhancement 130, geometric manipulations of the layout are performed to improve manufacturability of the design. Example EDA software products from Synopsys, Inc. of Mountain View, Calif. that can be used at this stage include: Proteus®, Proteus®AF, and PSMGED® products.

During mask-data preparation 132, the ‘tape-out’ data for production of masks to produce finished chips is provided. Example EDA software products from Synopsys, Inc. of Mountain View, Calif. that can be used at this stage include the CATS® family of products.

Formal verification may be performed at the stage of logic design and functional verification 116. Low power design specification is typically processed during stages synthesis and design for test 118 or netlist verification 120. Embodiments process low power design specification early, as part of the formal verification process.

### System Architecture

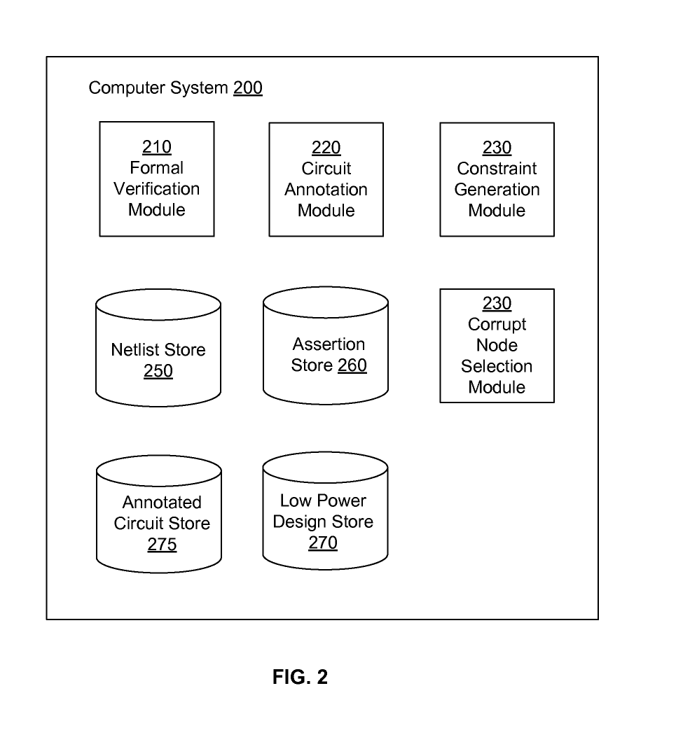

FIG. 2 illustrates the system architecture for formal verification of circuits with low power design considerations, according to an embodiment. The computer architecture illustrated in FIG. 2 comprises a computer system 200 comprising a formal verification module 210, a circuit annotation module 220, a constraint generation module 230, a netlist store 250, a an assertion store 260, a low power design store 270, a corrupt node selection module 230, and an annotated circuit store 275.

In one embodiment, the computer system 200 can be a conventional computer system executing, for example, a Microsoft Windows-compatible operating system (OS), Apple OS X, and/or a Linux distribution. Some embodiments of the computer system 200 have different and/or other modules than the ones described herein, and the functions can be distributed among the modules in a different manner than described here. For example, the computer system 200 might also include modules for receiving electronic circuit information via a network or modules for transmitting results via the network.

The formal verification module 210 performs formal verification of assertions related to a circuit. The input to the formal verification module 210 includes a set of assertions and constraints. The formal verification module 210 determines whether the assertions and constraints are valid. If the formal verification module 210 determines that the assertions and constraints are not valid, the formal verification module 210 generates a counter example where the assertions and constraints fail.

The constraint generation module 230 generates a set of constraints based on low power specification of a circuit. The set of constraints generated represents power states of power domains specified in the low power design specification. The constraint generation module 230 provides the generated constraints as input to the formal verification module 210, to perform formal verification with low power considerations.

The netlist store 210 stores the information describing the netlists for the electronic circuits. The information stored in the netlist includes various components of the circuit and their interconnections. In an embodiment, the netlist of a circuit may be represented as a graph comprising nodes representing components and edges representing interconnections between the components.

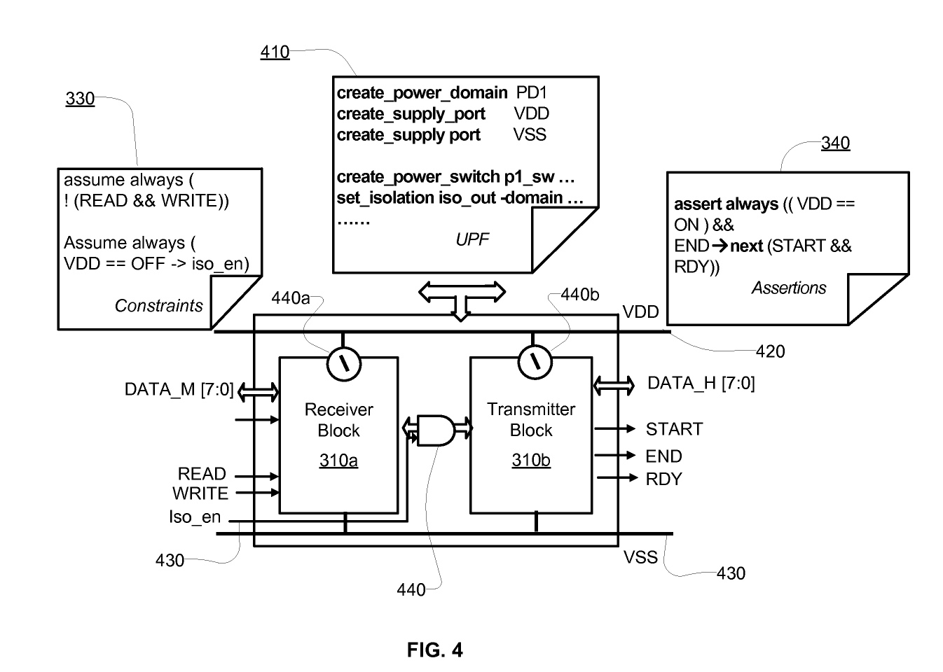

The assertion store 260 stores assertions representing circuits. An assertion may represent connectivity of a circuit. In an embodiment, the assertions are represented as expressions, each expression specifying connectivity between components of a circuit. FIG. 4 describes an example circuit with assertions representing the connectivity of the circuit. The assertions are provided to the formal verification module 210 for performing formal verification of connectivity of a circuit.

The low power design store 270 stores the low power design specification of circuits. In an embodiment, the low power design specification is specified using the unified power format (UPF.) The low power design specification describes various power domains of a circuit, valid power states of the power domains of the circuit, and also circuit design elements for introducing in the circuit based on low power considerations, for example, isolation cells. The low power design specification stored in low power design store 270 is provided as input to the constraint generation module 230 to generate constraints based on the low power specification. The constraint generation module 230 provides the generated constraints as input to the formal verification module 210.

The circuit annotation module 220 modifies an input circuit based on low power design specification. The circuit annotation module 220 may introduce design elements in the circuit based on the low power design specification. For example, the circuit annotation module 220 may include isolation cells between components belonging to two different power domains specified in the low power specification. The circuit annotation module 220 may introduce additional components to be able to inject undefined signals in the circuit at selected nodes of the circuit. An undefined signal is represented by an unconstrained variable that can take any possible logical value. The circuit annotation module 220 stores the annotated circuit in the annotated circuit store 275.

The corrupt node selection module 230 selects nodes of the input circuit that received undefined signals from components of power domains that are switched off. The selected nodes are also referred to herein as corrupted nodes. The corrupt node selection module 230 selects corrupt nodes so as to minimize the number of corrupt nodes that are provides to the circuit annotation module 220, thereby reducing the complexity of the annotated circuit and the complexity of the formal verification process. The corrupt node selection module 230 excludes nodes if the corrupt node selection module 230 determines that excluding the node in the formal verification does not affect the outcome of the formal verification with low power considerations. The corrupt node selection module 230 provides the selected nodes to the circuit annotation module 220 for annotating the circuit to be able to inject undefined signals at the selected nodes.

### Formal Verification

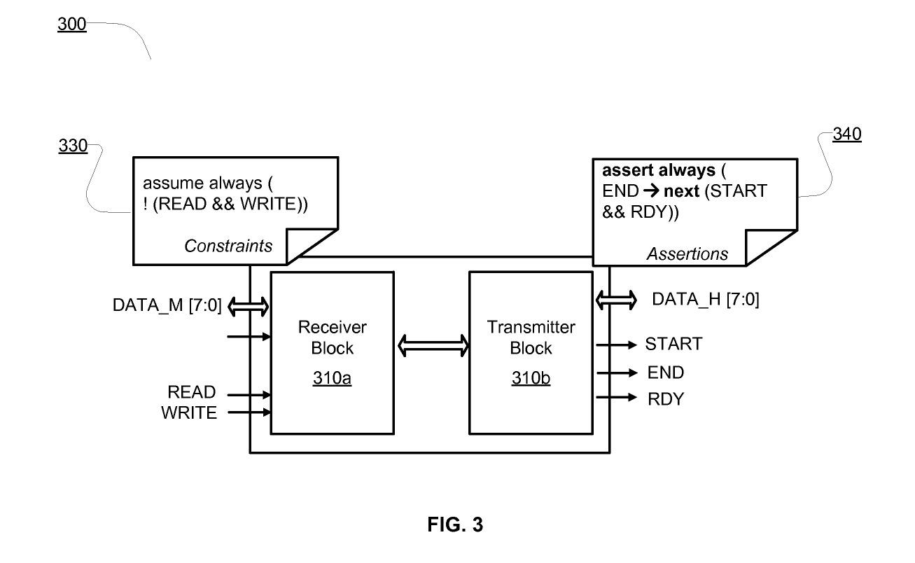

FIG. 3 shows an example circuit for use as input for formal verification, according to an embodiment. Figure (FIG. 3 and the other figures use like reference numerals to identify like elements. A letter after a reference numeral, such as “310a,” indicates that the text refers specifically to the element having that particular reference numeral. A reference numeral in the text without a following letter, such as “310,” refers to any or all of the elements in the figures bearing that reference numeral (e.g. “310” in the text refers to reference numerals “310a” and/or “310b” in the figures).

As shown in FIG. 3, the circuit may include one or more blocks 310 of components. Each block may include combinational components such as gates as well sequential components (or elements), for example, flip-flops. The components are connected via nets. FIG. 3 shows an example circuit with two blocks, a receiver block 310a and a transmitter block 310b.

The blocks 310 typically have inputs and outputs. FIG. 3 shows that receiver block 310a has inputs DATA_M, READ and WRITE and the transmitter block 310b has outputs DATA_H, START, END, and READY. Two blocks may be connected with each other via nets such that output signals from a block provide inputs to the other block. For example, outputs from the receiver block 310a may be provided as input to the transmitter block 310b.

Embodiments perform formal verification of circuits such as the circuit shown in FIG. 3. The formal verification process receives certain assertions and constraints for a circuit. The assertions represent properties describing the circuit. The constraints represent facts given for the circuit and are assumed to be true. FIG. 3 shows examples of constraints 330 and assertions 340.

The design of the circuit 300 may include low power specification. The low power specification specifies one or more power domains. A power domain specifies a set of components of the circuit and associated criteria determining when the power for the set of components is switched on/off. For example, the circuitry associated with a screen may get turned on/off based on a particular criteria, other circuitry may be turned off/on based on a different criteria.

The circuit design may specify the power domains and criteria describing when a power domain is switched on/off using a UPF specification. The UPF specification for the circuit may specify valid combinations of power modes for the chip. If an input of a component C1 in one domain is driven by a component C2 from another domain that is off, the component C1 gets undefined input. The, UPF specification may include isolation devices to protect components from receiving invalid inputs.

Conventionally, the low power specification is processed very late in the design cycle after formal verification is already performed. Accordingly, conventional techniques realize very late that the results of formal verification are incorrect in view of low power specification. Embodiments consider low power specification early in the design stages, i.e., while performing formal verification to ensure that the formal verification results are consistent with the low power specification.

FIG. 4 shows an example of circuit illustrating annotations of the circuit based on low power specification, according to an embodiment. The low power design specification may include descriptions of power domains. For example, the low power design specification 410 may include a statement “create_power_domain PD1” to specify a power domain PD1. The low power design specification 410 may also specify power supply ports, for example, using a statement “create_supply_port”.)

The circuit design is annotated based on the low power design specification. For example, the power supply inputs VDD 420 and VSS 430 are added to the circuit design. Switches 440a and 440b are added to connect the power supplies to the blocks of circuits associated with the power domain. Isolation cells 440 may be introduced between blocks associated with different power domains. Inputs 430 for enabling/disabling isolation cells 440 are introduced, for example, signal Iso en. Embodiments modify constraints 330 and assertions 340 based on the low power design specification. For example, the constraint generation module 230 may specify constraints based on when the inputs 430 for isolation cells 440 are on/off. Similarly, the constraint generation module 230 may modify the assertions based on power states of the power domains.

The circuit annotation module 220 introduces corruption signals are to model undefined signals caused by power domains switching off. For example, if the power domain corresponding to a block 310 is turned off, the components of the block 310 output undefined signal. An undefined signal is a signal that can take any logical value possible in the circuit for example, zero or one.

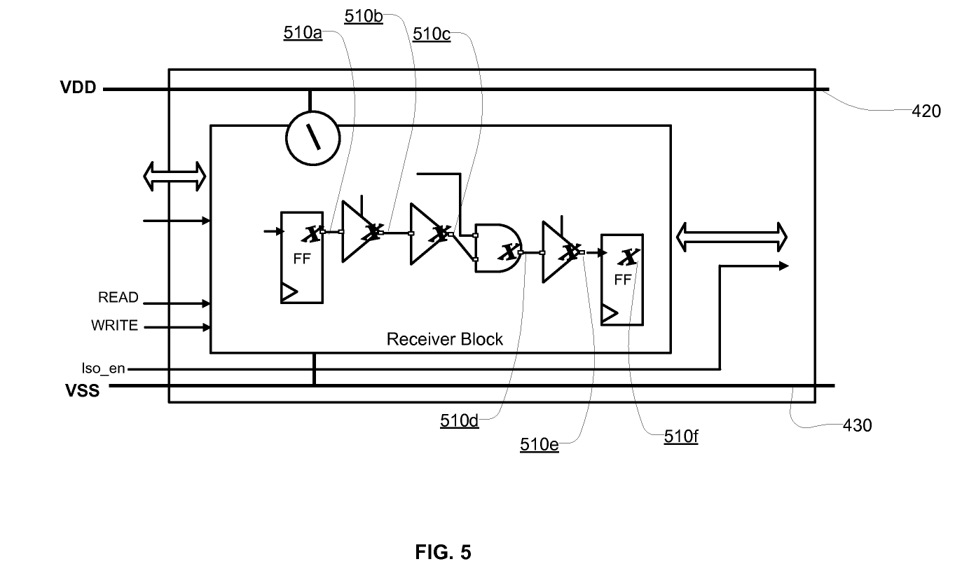

FIG. 5 shows various nodes of a block of circuit that need to be modeled with undefined signals as input as a result of the power domain of the circuit block turning off, according to an embodiment. The undefined signal 510 may correspond to an output of a combinational circuit component or a sequential component. For example, as shown in FIG. 5, undefined signals 510a and 510f correspond to sequential components and undefined signals 510b, 510c, 510d, and 510f correspond to outputs of combinational circuit elements.

Each undefined signal injected into the annotated circuit is modelled as an unconstrained variable that can take any possible logical value, for example, 0, 1, X and Z. The complexity of formal verification of an annotated circuit is typically more than the complexity of the input circuit by a factor exponential in the number of nodes in which undefined signal is injected. Embodiments reduce the number of nodes in which the undefined signal is injected, thereby reducing the complexity of the formal verification performed by a naïve implementation.

### Overall Process of Formal Verification Using Annotated Circuit Design

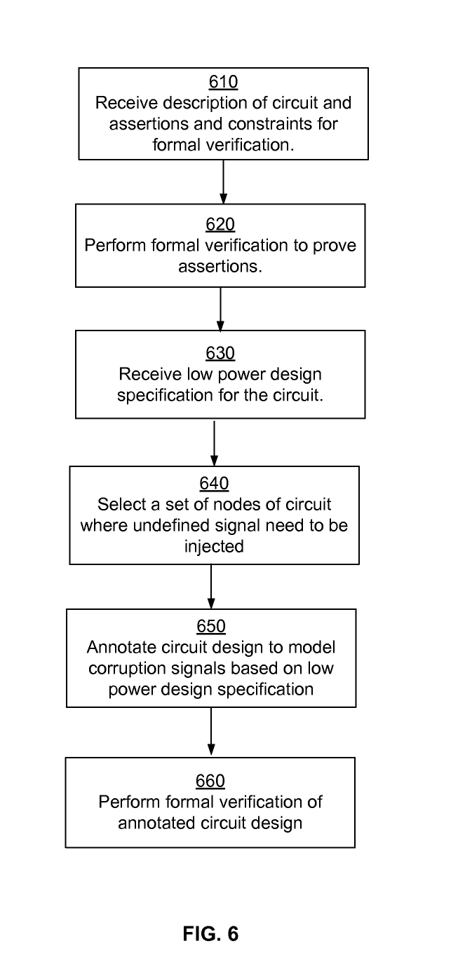

FIG. 6 is a flowchart illustrating the process for performing formal verification of a circuit with low power design considerations, according to an embodiment. The formal verification module 210 receives 610 a description of a circuit along with assertions and constraints for performing formal verification of the circuit. The description of the circuit is stored in the netlist store 250 and the assertions and constraints are stored in the assertion store 260. The formal verification module 210 performs 620 formal verification of the input circuit based on the assertions and constraints. If the assertions are determined to be false, the formal verification module 210 provides the results to a user allowing the user to make modifications to the circuit to fix the circuit. If the assertions are determined to be true, the formal verification module 210 proceeds with the formal verification with low power considerations.

The formal verification module 210 receives 630 low power design specification for the circuit. The low power design specification may be stored in the low power design store 270. In an embodiment, the low power design is specified using UPF format.

The corrupt node selection module 230 selects 640 a set of nodes of the circuit for injecting undefined signal for performing formal verification in view of low power design considerations. If the corrupt node selection module 230 selected all nodes of power domains that switch off and carry the undefined signal, the formal verification process will perform very inefficiently since the number of such nodes can be very large. Therefore, the corrupt node selection module 230 selectively identifies nodes for injecting the undefined signal and excludes several nodes from the set of nodes based on various criteria.

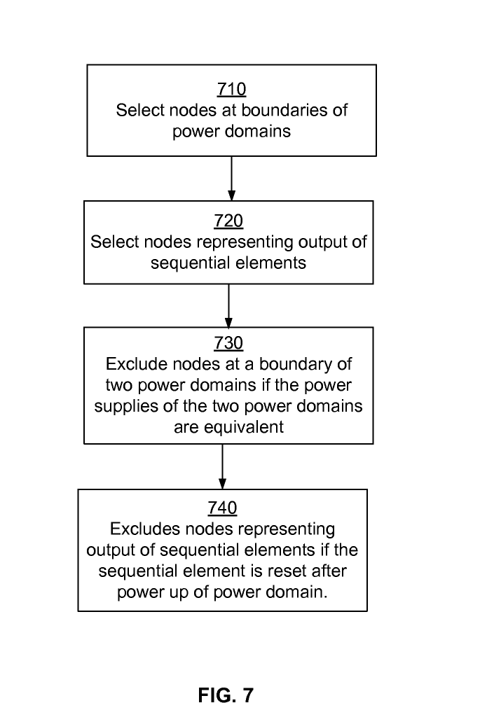

The corrupt node selection module 230 selects 640 the set of nodes so as to exclude one or more nodes that have undefined signal as a result of a power domain switching off. The corrupt node selection module 230 selects the nodes such that excluding the one or more nodes does not affect the accuracy of the formal verification process. Accordingly, the formal verification process achieves the same formal verification result by annotating the reduced set of nodes as it would by annotating all nodes that have undefined signal as a result of switching off the power domain. The process of annotation of the circuit minimizes the number of nodes to which the undefined signal is injected without affecting the correctness of the formal verification process. Details of the process for selecting 640 the set of nodes for injecting undefined signal are described below in the flowchart shown in FIG. 7.

The circuit annotation module 220 modifies the circuit design by annotating 650 the circuit design based on low power considerations. The circuit annotation module 220 annotates the circuit with various design elements including the power supplies, isolation cells, enable/disable signals for the isolation cells and so on. The circuit annotation module 220 annotates the circuit design to inject undefined signals in the nodes belonging to the set of nodes selected 640. The constraint generation model 230 introduces various constraints representing the power states of the power domains specified in the low power design specification.

The formal verification module 210 performs 660 formal verification of the annotated circuit. If the formal verification determines 660 that all assertions are true, the formal verification module 210 reports the results. If the formal verification module 210 determines that an assertion is false, the formal verification module 210 generates a counter example, indicating that there are issues with the circuit in view of the low power design. The formal verification module 210 sends the results of the formal verification in view of low power design considerations, for example, to the user.

FIG. 7 is a flowchart illustrating the process for selecting nodes of a circuit for injecting undefined signals based on the low power design, according to an embodiment. The corrupt node selection module 230 selects 710 nodes at boundaries of power domains for injecting undefined signal. These include nodes that connect components of a power domain with components outside the power domain. Accordingly, the corrupt node selection module 230 excludes nodes that are internal to the power domain. A node is internal to a power domain if it connects two or more components within the power domain.

As an example, assume a component C1 is in the power domain PD1 and component C2 is outside the power domain PD1 and C1 and C2 are connected by a node N1. In this example, the node N1 is a boundary node of the power domain. The components C1 and C2 can be connected such that either C1 provides input to component C2 via node N1 or component C2 provides input to component C1 via node N1. Similarly assume that components C3 and C4 are connected by node N2. Also assume that both C3 and C4 are within the same power domain PD1. Accordingly, node N2 is internal to the power domain PD1 and is excluded by the corrupt node selection module 230 (unless N2 is connected to the output of a sequential element belonging to the power domain PD1).

The corrupt node selection module 230 further selects 720 nodes representing outputs of sequential elements such as flip-flops, even if these nodes are internal to a power domain. Unlike combinational elements, sequential elements can store a state after the inputs of the sequential elements have changed. Therefore, the corrupt node selection module 230 selects 720 sequential elements for injecting undefined signals even if the sequential element is internal to the power domain and the output of the sequential element is not a boundary node.

The corrupt node selection module 230 excludes 730 nodes at the boundaries of two power domains if the corrupt node selection module 230 determines that the power supplies of the two power domains are equivalent. The corrupt node selection module 230 determines that the power supplies of the two power domains are equivalent based on their power state tables. The corrupt node selection module 230 determines that two power domains are equivalent if the power state tables specified in the low power design specification indicate that the two power domains are either both on or both off together. For example, if there are two power domains P1 and P2, and P1 and P2 are either both off or both on based on the low power design specification, the power domains P1 and P2 are determined to be equivalent.

The corrupt node selection module 230 excludes nodes that connect two power domains with equivalent power supplies from the set of nodes selected for injecting undefined signals. Accordingly, if there is a chain of combinational components connecting the two power domains, the corrupt node selection module 230 excludes the nodes connecting the combinational components of the chain from the set of nodes for which undefined signal is injected.

In general, the corrupt node selection module 230 excludes a node from the set of nodes for which undefined signal is injected if the node connects two combinational components that are connected to two power supplies that are equivalent based on the low power design specification. The corrupt node selection module 230 also excludes a node from the set of nodes for which undefined signal is injected if the node connects two combinational components that are connected to the same power supply since a power supply is equivalent to itself.

The corrupt node selection module 230 excludes 740 nodes that represent output of sequential elements if the sequential element is reset after the power domain switches on after being switched off. The corrupt node selection module 230 receives information describing behavior of a power controller circuit for the circuit design. The corrupt node selection module 230 determines if the power controller circuit resets sequential elements of a power domain when the power domain switches to on state from an off state.

The state of the output of sequential element of a power domain is undefined after the power domain turns on from an off state since the sequential element can maintain state. However, the power controller circuit may include logic to modify the state of the sequential element to a well-defined state from the undefined state. The corrupt node selection module 230 determines if the power controller circuit resets the state of the sequential element of the power domain to a well-defined state after the power domain turns on from an off state. If the state of a sequential element is reset (or modified to a well-defined state) after the power domain the corrupt node selection module 230 excludes the node corresponding to the output of the sequential element from the set of nodes selected for injecting undefined signal.

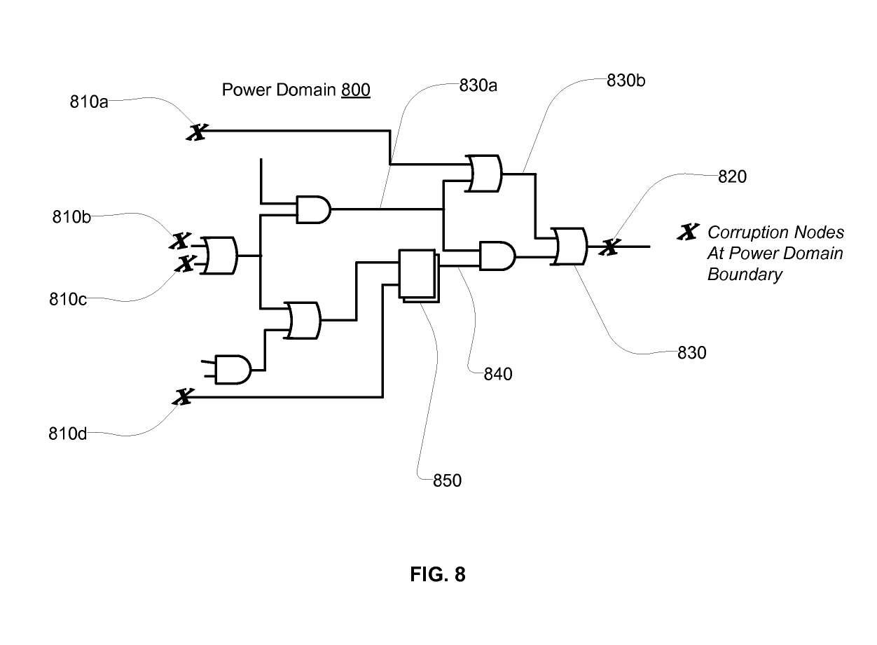

FIG. 8 shows an example circuit illustrating the selection of boundary nodes and sequential elements for injecting undefined signals based on the low power design, according to an embodiment. As shown in FIG. 8, nodes 810a, 810b, 810c, and 810d provide input to components of power domain 800 from components outside the power domain. Therefore the corrupt node selection module 230 selects 710 nodes 810a, 810b, 810c, and 810d as boundary nodes of power domain 800. Node 820 provides output of component 830 to components outside the power domain 800. Accordingly, the corrupt node selection module 230 selects 710 node 820 as a boundary node of power domain 800. The nodes 830a, 830b represent examples of nodes that are internal to power domain 800 since they connect two or more nodes that all belong to the power domain 800. FIG. 8 shows node 840 as an output of sequential element 850 as an example of an internal node that is selected 720 by the corrupt node selection module 230 for injecting undefined signals for annotating the circuit design for formal verification with low power considerations.

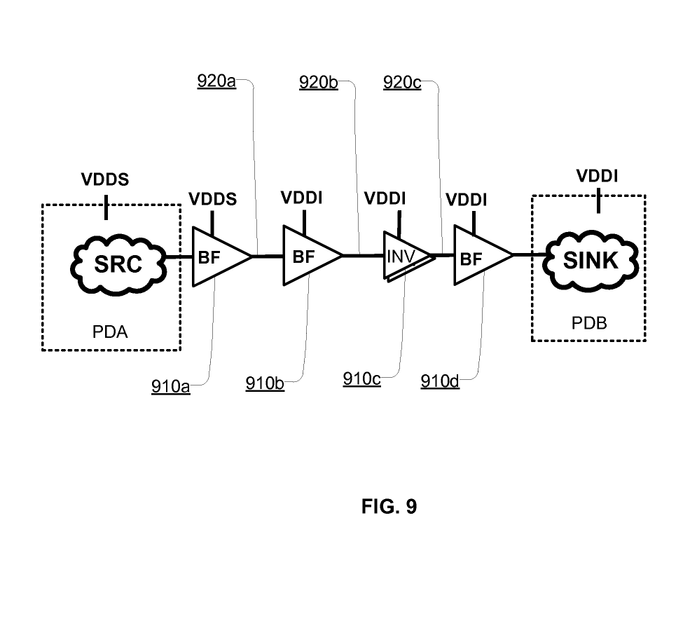

FIG. 9 shows an example circuit illustrating elimination of nodes at boundary of two power domains from the set of nodes selected for corruption modeling if the two power domains have equivalent power states, according to an embodiment. FIG. 9 shows power domain PDA and power domain PDB. The low power specification specifies that power domain PDA is powered by power supply VDDS and power domain PDB is powered by power supply VDDI.

The corrupt node selection module 230 determines that the power supplies VDDS and VDDI are equivalent based on power state tables specified in the low power design. Accordingly, the corrupt node selection module 230 excludes nodes 920a, 920b, and 920c that connect the power domains PDA and PDB from the set of nodes selected for injecting undefined signals. The corrupt node selection module 230 excludes nodes 920b and 920c since they connect components 910b, 910c, and 910d that are powered by the same power supply VDDI and a power supply is determined to be equivalent to itself.

The corrupt node selection module 230 also excludes node 920a even though it connects components 910a and 910b that are powered by different power supplies, i.e., components 910a is supplied by power supply VDDS and components 910b is supplied by power supply VDDI. The corrupt node selection module 230 excludes node 920a since it connects components powered by power supplies VDDS and VDDI that are equivalent based on the power state tables specified in the low power specification.

The following figures illustrate how the circuit annotation module 220 annotates a circuit for injecting undefined signals. The circuit annotation module 2 annotates 650 the circuit by introducing one or more components associated with the node selected for injecting the undefined signal. A variable is introduced for representing the undefined signal. The value of the variable representing the undefined signal is un-constrained in the formal verification process. In other words the variable representing the undefined signal can take any possible logical value. Accordingly, the formal verification module 210 performs formal verification of the annotated circuit by assuming all possible logical values to the unconstrained variables.

FIG. 10 shows an example circuit illustrating annotation of a circuit for modelling power switch policy, according to an embodiment. A power switch policy specifies one or more power supply ports and conditions indicating when a particular power supply port provides power to a node. A power supply port is associated with an input supply net 1020 that connects the power supply port with an output supply net 1040 that provides power to components of a power domain.

FIG. 10 shows the components introduced in the circuit design by the circuit annotation module 220. The circuit annotation module 220 introduces a multiplexor 1010 for each input supply net 1020 specified by the low power design. The output of a multiplexor 1010a receiving input from an input supply net 1020a is provided as input to a multiplexor 1010b receiving input from another input supply net 1020b. The selector 1030 for each multiplexor is defined by a condition specified in the low power specification determining when the signal from the corresponding input supply net 1020 is provided at the output supply net 1040. A multiplexor 1010c is introduced to receive an undefined signal 1020c based on the selector 1030c.

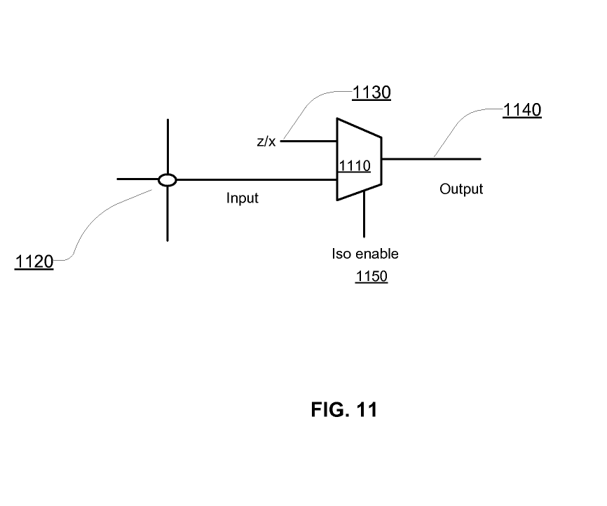

FIG. 11 shows an example circuit illustrating annotation of a circuit for modelling an isolation policy, according to an embodiment. An isolation policy specifies conditions for isolating output of a power domain from inputs of another power domain. For example, the low power specification may specify circuit components to isolate power domains from receiving undefined signals provided by components from other power domains that are off. The circuit annotation module 220 introduces a multiplexor 1110 between the input node 1120 and output node 1140. The undefined signal 1130 is provided as an input of the multiplexor. The multiplexor select 1150 input is based on conditions specified in the low power design indicating when the two power domains should be isolated.

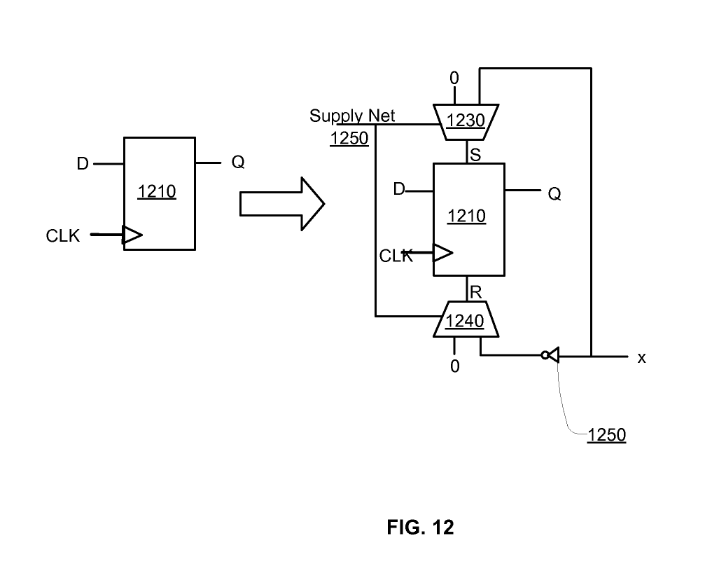

FIG. 12 shows an example circuit illustrating annotation of a circuit for modelling corruption of a sequential element of a circuit, according to an embodiment. The input circuit includes a sequential element 1210, for example, a flip flop. The sequential element 1210 receives an input D and a clock input CLK, and has output Q. The circuit annotation module 220 introduces multiplexors 1230 and 1240 for setting the output q of the sequential element 1210 to an undefined value. The undefined value is provided as input signal X.

The role of the different components introduced is as follows. The multiplexor 1230 provides input to the signal S that sets the output of the sequential element 1210 to true. The multiplexor 1240 provides input to the signal R that resets the output of the sequential element 1210 to false. The signal X is input directly to the multiplexor 1230 and input via inverter 1240 to the multiplexor 1240. The supply_net 1250 signal controls the selector of the multiplexors 1230 and 1240. Accordingly, if the supply_net 1250 signal is 0, both the set and reset inputs are 0, thereby disabling the set and reset inputs. However, if the supply_net value 1250 is 1, the outputs of the multiplexors 1230, 1240 are controlled by the X signal. Accordingly, when supply_net 1250 is 0, and X is 1, the sequential element 1210 is set to 1 and if X is 0, the sequential element 1210 is set to 0. Accordingly, the components introduced allow the output of the sequential element 1210 to be set to any value corresponding to the undefined signal X.

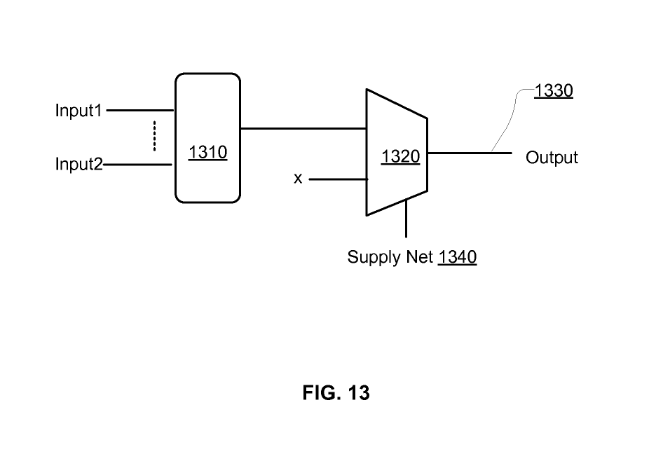

FIG. 13 shows an example circuit illustrating annotation of a circuit for modelling corruption of an operator, according to an embodiment. As shown in FIG. 13, circuit annotation module 220 injects the undefined signal X at the output of operator 1310 by adding a multiplexor 1330 at the output of the operator. The multiplexor 1320 receives the value X representing the undefined signal as one input and the output of the operator 1310 as the other input. The selector input of the multiplexor is the supply_net signal 1340. Accordingly, if the supply_net signal is 0, the multiplexor 1320 selects the undefined input X. On the other hand if the supply_net signal is 1, the multiplexor 1320 selects the output of the operator 1310.

The circuits in FIGS. 10-13 show examples of annotated circuits generated by the circuit annotation module 220 for modeling introduction of the undefined signal at various nodes of the input circuit. The formal verification module 210 performs formal verification of the annotated circuit. The result of the formal verification of the annotated circuit is provides as the result of the formal verification of the input circuit with low power considerations.

### Computer Architecture

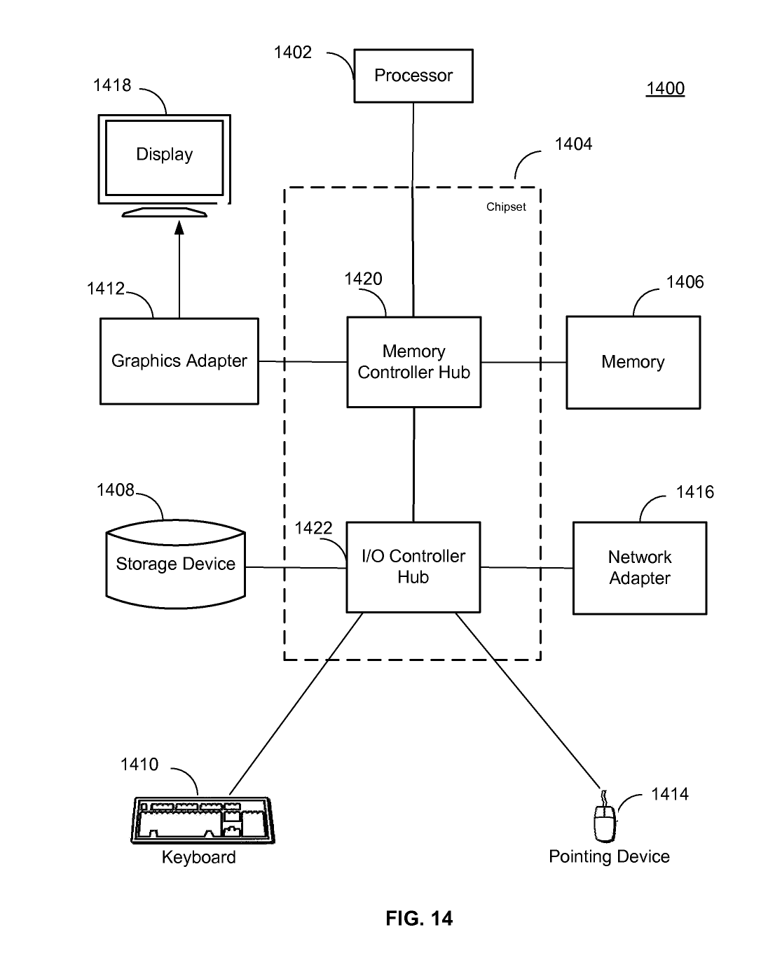

FIG. 14 is a high-level block diagram illustrating an example of a computer for use in compression of scenarios, in accordance with an embodiment. The computer 1400 includes at least one processor 1402 coupled to a chipset 1404. The chipset 1404 includes a memory controller hub 1420 and an input/output (I/O) controller hub 1422. A memory 1406 and a graphics adapter 1412 are coupled to the memory controller hub 1420, and a display 1418 is coupled to the graphics adapter 1412. A storage device 1408, keyboard 1410, pointing device 1414, and network adapter 1416 are coupled to the I/O controller hub 1422. Other embodiments of the computer 1400 have different architectures.

The storage device 1408 is a non-transitory computer-readable storage medium such as a hard drive, compact disk read-only memory (CD-ROM), DVD, or a solid-state memory device. The memory 1406 holds instructions and data used by the processor 1402. The pointing device 1414 is a mouse, track ball, or other type of pointing device, and is used in combination with the keyboard 1410 to input data into the computer system 1400. The graphics adapter 1412 displays images and other information on the display 1418. The network adapter 1416 couples the computer system 1400 to one or more computer networks.

The computer 1400 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 1408, loaded into the memory 1406, and executed by the processor 1402. The types of computers 1400 used can vary depending upon the embodiment and requirements. For example, a computer may lack displays, keyboards, and/or other devices shown in FIG. 14.

### Alternative Embodiments

Some portions of above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for formal verification of circuit in view of low power considerations. Thus, while particular embodiments and applications have been illustrated and described, it is to be understood that the embodiments are not limited to the precise construction and components disclosed herein and that various modifications, changes and variations which will be apparent to those skilled in the art may be made in the arrangement, operation and details of the method and apparatus disclosed herein without departing from the spirit and scope as defined in the appended claims.

What is claimed is:

1. A computer-implemented method for performing formal verification of a circuit in view of low power design specification, the method comprising:
receiving a request to perform formal verification of an input circuit;
receiving low power design specification for the input circuit, the low power design specification identifying power domains, each power domain associated with one or more components of the input circuit, the input circuit comprising a set of corrupted nodes, each corrupted node receiving an undefined signal from a component of a power domain that is switched off;
selecting a subset of the set of corrupted nodes for injecting undefined signals at the selected corrupted nodes for performing formal verification;
annotating the circuit design to be able to provide an undefined signal at each of the subset of corrupted nodes;
performing formal verification of the annotated circuit design.

2. The computer-implemented method of claim 1, wherein annotating the circuit design to provide an undefined signal at a corrupted node comprises adding one or more components to the circuit design to allow the signal of the corrupted node to be set based on an input representing the undefined signal.

3. The computer-implemented method of claim 1, wherein selecting the subset of corrupted nodes comprises:
determining if a node is associated with a boundary of the power domain; and
including the node in the subset of corrupted nodes if the node is associated with a boundary of the power domain.

4. The computer-implemented method of claim 3, wherein a node is determined to be associated with the boundary of the power domain if the node is connected to a first component belonging to the power domain and a second component outside the power domain.

5. The computer-implemented method of claim 4, wherein the node connects an output of the first component belonging to the power domain with an input of the second component outside the power domain.

6. The computer-implemented method of claim 4, wherein the node connects an output of the second component outside the power domain with an input of the first component belonging to the power domain.

7. The computer-implemented method of claim 1, wherein selecting the subset of corrupted nodes comprises:
determining if a node is an internal node of the power domain, wherein an internal node connects a plurality of combinational components, each of the plurality of combinational components belonging to the power domain; and
determining that the node is not included in the subset of corrupted nodes if the node is determined to be an internal node of the power domain.

8. The computer-implemented method of claim 1, wherein identifying the set of nodes comprises:
determining if a node is connected to an output of a sequential element belonging to the power domain; and
including the node in the subset of corrupted nodes if the node is determined to be the output of the sequential element belonging to the power domain.

9. The computer-implemented method of claim 1, wherein identifying the subset of corrupted nodes comprises:
determining if a node connects a first component powered by a first power supply with a second component powered by a second power supply; and
including the node in the subset of corrupted nodes based on the determination that the first power supply is distinct from the second power supply.

10. The computer-implemented method of claim 9, further comprising:
determining if the first power supply is equivalent to the second power supply based on the low power design specification; and
wherein the node is included in the subset of corrupted nodes if the first power supply is determined to be not equivalent to the second power supply.

11. The computer-implemented method of claim 1, wherein selecting the subset of corrupted nodes comprises:
determining not to include a node in the subset of corrupted nodes if the node connects a first component powered by a first power supply with a second component powered by a second power supply and the first power supply is equivalent to the second power supply based on the low power design specification.

12. The computer-implemented method of claim 1, wherein selecting the subset of corrupted nodes comprises:
determining not to include a node in the subset of corrupted nodes if the node is connected to an output of a sequential element of the power domain wherein a power supply controller resets the state of the sequential element if the power domain switches from an off state to an on state.

13. The computer-implemented method of claim 1, wherein selecting the subset of corrupted nodes comprises:
identifying a node connected to an output of a sequential element of the power domain;
determining if a power supply controller resets state of the sequential element when the power domain switches from off state to on state; and
including the node in the subset of corrupted nodes if the power supply controller is determined not to reset the state of the sequential element when the power domain switches from off state to on state.

14. A non-transitory computer readable storage medium storing instructions for:
receiving a request to perform formal verification of an input circuit;
receiving low power design specification for the input circuit, the low power design specification identifying power domains, each power domain associated with one or more components of the input circuit, the input circuit comprising a set of corrupted nodes, each corrupted node receiving an undefined signal from a component of a power domain that is switched off;
selecting a subset of the set of corrupted nodes for injecting undefined signals at the selected corrupted nodes for performing formal verification;
annotating the circuit design to be able to provide an undefined signal at each of the subset of corrupted nodes;
performing formal verification of the annotated circuit design.

15. The non-transitory computer readable storage medium of claim 14, wherein annotating the circuit design to provide an undefined signal at a corrupted node comprises adding one or more components to the circuit design to allow the signal of the corrupted node to be set based on an input representing the undefined signal.

16. The non-transitory computer readable storage medium of claim 14, wherein selecting the subset of corrupted nodes comprises:
determining if a node is associated with a boundary of the power domain; and
including the node in the subset of corrupted nodes if the node is associated with a boundary of the power domain.

17. The non-transitory computer readable storage medium of claim 14, wherein selecting the subset of corrupted nodes comprises:
determining if a node is an internal node of the power domain, wherein an internal node connects a plurality of combinational components, each of the plurality of combinational components belonging to the power domain; and
determining that the node is not included in the subset of corrupted nodes if the node is determined to be an internal node of the power domain.

18. The non-transitory computer readable storage medium of claim 14, wherein identifying the set of nodes comprises:
determining if a node is connected to an output of a sequential element belonging to the power domain; and
including the node in the subset of corrupted nodes if the node is determined to be the output of the sequential element belonging to the power domain.

19. The non-transitory computer readable storage medium of claim 14, wherein selecting the subset of corrupted nodes comprises:
identifying a node connected to an output of a sequential element of the power domain;
determining if a power supply controller resets state of the sequential element when the power domain switches from off state to on state; and
including the node in the subset of corrupted nodes if the power supply controller is determined not to reset the state of the sequential element when the power domain switches from off state to on state.

20. A computer-implemented system for performing formal verification of circuits with low power considerations, the system comprising:
a computer processor; and
a computer-readable storage medium storing instructions for:
receiving a request to perform formal verification of an input circuit;
receiving a request to perform formal verification of an input circuit;
receiving low power design specification for the input circuit, the low power design specification identifying power domains, each power domain associated with one or more components of the input circuit, the input circuit comprising a set of corrupted nodes, each corrupted node receiving an undefined signal from a component of a power domain that is switched off;
selecting a subset of the set of corrupted nodes for injecting undefined signals at the selected corrupted nodes for performing formal verification;
annotating the circuit design to be able to provide an undefined signal at each of the subset of corrupted nodes;
performing formal verification of the annotated circuit design.
